(19) United States
(12) Patent Application Publication
(10) Pub. No.: US 2024/0021204 A1
(43) Pub. Date: Jan. 18, 2024

(54) SYSTEM AND METHOD FOR TRANSCRIPTION WORKFLOW

(71) Applicant: VIQ Solutions Inc., Mississauga (CA)

(72) Inventors: Thomas Deplonty, Mississauga (CA); Gilles-André Morin, Mississauga (CA)

(73) Assignee: VIQ Solutions Inc., Mississauga (CA)

(21) Appl. No.: 17/664,536

(22) Filed: May 23, 2022

(51) Int. Cl. G10L 15/32; G10L 15/30; G10L 15/16; G10L 15/22; G06F 16/683

(52) U.S. Cl. CPC G10L 15/32; G10L 15/30; G06F 16/685; G10L 15/22; G10L 15/16

(57) ABSTRACT

Systems, methods, and computer-readable storage media for making assignments to different speech-to-text engines based on previous transcription scores. An exemplary system can train a model by receiving a first digital audio recording, randomly assigning speech-to-text engines to transcribe the first digital audio recording, and scoring the resulting transcriptions and scoring the engines based on their performances. The system can then generate a model for selecting a speech-to-text engine from within the speech-to-text engines. When a second digital audio recording is received, the system can assign, by executing the model, at least one selected speech-to-text engine from the speech-to-text engines to transcribe the second digital audio recording.

### BACKGROUND

### 1. Technical Field

The present disclosure relates to voice to text processing, and more specifically to scoring the accuracy of voice to text transcription engines based on factors such as speed and accuracy, then training the system to obtain the optimum transcription based on those scores.

### 2. Introduction

The general idea behind using automated speech-to-text systems for transcribing documents is to reduce the need for human beings to do the transcribing. While in some cases the transcription produced by the speech-to-text system can be a “final” version, where no humans edit or confirm the correctness of the transcription, in other cases a human being can edit the transcription, with the goal of saving time by not having a human do the initial transcription (just the editing). However, in practice, editing an already drafted document is often more time intensive for human beings than simply doing the transcription from scratch. Part of the reason for the discrepancy between the projected time savings of using a speech-to-text system and the reality is that transcribing a document from a recording, and editing a document to ensure it aligns with the recording, are different skills.

To counter this problem, engineers have attempted to create context-specific speech-to-text systems, where the speech recognition is particularly tailored to a given context or topic. In such systems, the vocabulary and the combinations of phonemes (e.g., diphones and triphones) can result in improved speech recognition. However, determining which context-specific speech-to-text system is appropriate for a given scenario remains a problem.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computer system, a first digital audio recording; randomly assigning, via a processor of the computer system, speech-to-text engines to transcribe the first digital audio recording, resulting in transcriptions, each transcription within the transcriptions respectfully associated with a speech-to-text engine within the speech-to-text engines; scoring, via the processor, the transcriptions based on transcription scoring factors, resulting in transcription scores; scoring, via the processor and based at least in part on the transcription scores and speech-to-text engine scoring factors, the speech-to-text engines, resulting in speech-to-text engine scores; generating, via the processor and based at least in part on the speech-to-text engine scores, a model for selecting a speech-to-text engine from within the speech-to-text engines; receiving, at the computer system, a second digital audio recording; and assigning, via the processor executing the model, at least one selected speech-to-text engine from the speech-to-text engines to transcribe the second digital audio recording.

A system configured to perform the concepts disclosed herein can include: a modeling repository; a score database; at least one processor; and a non-transitory computer-readable storage medium having instructions stored which, when executed by the at least one processor, cause the at least one processor to perform operations comprising: executing a task manager service; and executing a scoring service; wherein the system generates a speech-to-text engine assignment model by: receiving a first digital audio recording; randomly assigning, via the task manager service, speech-to-text engines to transcribe the first digital audio recording, resulting in transcriptions, each transcription within the transcriptions respectfully associated with a speech-to-text engine within the speech-to-text engines; scoring the transcriptions based on transcription scoring factors, resulting in transcription scores; storing the transcription scores in the score database; scoring, based at least in part on the transcription scores stored in the score database and speech-to-text engine scoring factors, the speech-to-text engines, resulting in speech-to-text engine scores; storing the transcription scores in the score database; generating, based at least in part on the speech-to-text engine scores stored in the score database, a model for selecting a speech-to-text engine from within the speech-to-text engines for a future transcription; and storing the model in the modeling repository; and wherein the system uses the model to make additional speech-to-text engine assignments by: receiving a second digital audio recording; retrieving the model from the modeling repository; and assigning, by executing the model, a particular speech-to-text engine from the speech-to-text engines to transcribe the second digital audio recording.

A non-transitory computer-readable storage medium configured as disclosed herein can have instructions stored which, when executed by a computing device, cause the computing device to perform operations which include: receiving a first digital audio recording; randomly assigning speech-to-text engines to transcribe the first digital audio recording, resulting in transcriptions, each transcription within the transcriptions respectfully associated with a speech-to-text engine within the speech-to-text engines; scoring the transcriptions based on transcription scoring factors, resulting in transcription scores; scoring, based at least in part on the transcription scores and speech-to-text engine scoring factors, the speech-to-text engines, resulting in speech-to-text engine scores; generating, based at least in part on the speech-to-text engine scores, a model for selecting a speech-to-text engine from within the speech-to-text engines for a future transcription; receiving a second digital audio recording; and assigning, by executing the model, a particular speech-to-text engine from the speech-to-text engines to transcribe the second digital audio recording.

### BRIEF DESCRIPTION OF THE DRAWINGS

FIG. 1 illustrates a first example system embodiment;

FIG. 2 illustrates an example of creating and integrating a speech recognition configuration service into a system;

FIG. 3 illustrates an example of integrating cloud-based transcription services into the system;

FIG. 4 illustrates an example of integrating a predictor for a speech recognition configuration selection into the system

FIG. 5 illustrates an example of adding scoring of transcription jobs to the system;

FIG. 6 illustrates an example of integrating a predictor for speech recognition draft quality prediction;

FIG. 7 illustrates an example of ETL (Extract, Transform, Load) changes to support automated model updates;

FIG. 8 illustrates an example of updating prediction models automatically;

FIG. 9 illustrates a second example system embodiment;

FIG. 10 illustrates an example method embodiment; and

FIG. 11 illustrates an example computer system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

The present disclosure addresses how to determine which engine is appropriate for a given scenario, and uses AI (Artificial Intelligence) and a feedback/machine learning process to do so. The result is a system which can assign multiple engines to perform a task, score how those engines perform, and then assign subsequent tasks to one or more engines based on how those engines are previously scored. Framed in this manner, there are two phases: (1) the training of the system, where the various engines are scored for their accuracy, speed, cost, computational factors, etc.; and (2) predicting using machine learning models which of the various engines is best suited for a task. The machine learning models may be training in view of the results.

The training of the system can occur as the system is deployed, meaning that engines can be assigned to perform the task, and scores related to those tasks can be saved and used for future assignments. Of note, the training of the system can be more than a single iteration, and can be repeated as often as is necessary. In any additional training, the subsequent scores can replace the previous scores or can be used as additional scores which, together with the previous scores, the system can use to assign subsequent transcriptions.

Consider the following example in the context of a context specific speech to text system, although the architecture is not limited to this type of system, and may be used with video processing engines, etc. The system has access to various speech recognition engines, “A,” “B,” and “C.” Engines A, B, and C are randomly assigned to perform a received transcription job, converting speech to text using a combination of phoneme recognition and natural language processing (NLP). The resulting text from the randomly assigned engines is then analyzed and scored either manually or, preferably, using a machine-learning classifier, and those scores are used to assign future jobs.

The system herein can include and/or utilize various hardware and software components. In some configurations all of these hardware and software components can be included within a single computer system, such as a server. In other configurations, some of the hardware and software components may be co-located within a server while others are located on the cloud, and the system can enable communications to those remote components. Among the components are:
a “platform module,” a module incorporating databases, scoring services, and task managers;
a “transcription communication module,” a module from which transcription jobs and transcription job metadata can be obtained, and to which transcription results can be reported;
transcription services, which convert audio/speech files to text using one or more speech-to-text engines, resulting in transcriptions;
“Production Machine Learning (ML) Components,” which can include prediction APIs (Application Programming Interfaces), where the scores associated with the difference speech-to-text engines can be evaluated, and those scores can be incorporated as feedback; and
Modeling and/or research repositories (databases), storing models of how various speech-to-text engines, or combinations of such engines, can perform under various circumstances.

The system can initially receive the jobs through the transcription communication module, then again use the transcription communication module to deliver the transcriptions to users/customers after the transcription has been completed. At that point, metadata about the transcription (such as the job identification) can delivered to and/or used by platform module for automated word error scoring and recording. This error scoring can be used to update the ratings associated with the engine(s) that performed the transcription and/or other machine learning models.

Job metadata can be retrieved via a callback to the platform module caller. For the transcription communication module, platform module can call existing transcription communication module APIs to retrieve the metadata necessary for predictions regarding what engine(s) to use for the transcription process. Exemplary fields which may be used as part of the prediction process may include: a tenant identifier, a job identifier, a job type identifier, organizational identifiers (providing a relevant level of detail for the department, team, etc., associated with the job and/or parties associates with the job), critical time references (such as due dates and WIP (Work In Progress) deadlines), priority factors, author identifiers, job-specific metadata, template references, workflow parameters, etc.

In one example embodiment, the speech recognition configuration service can ignore most or all of this data, neither using it, nor storing it. However, in other example embodiments, after a prediction service has been initiated and configured, this data can be used to predict what engines are to be used. Instead of relying on the metadata in the initial implementation, the speech recognition configuration service can use a series of rules, that will be matched against a subset of this data. An exemplary subset can include: Instance, TenantID, OrganizationID, and DepartmentID. In other words, different subsets of attributes within the metadata can be selected, and based on the results of that subset different engines can be selected.

For example, the rules trigger on a subset including the instance, tenant, organization, and department for a specific piece of multimedia to specify how the configuration (i.e., which engines to use) decision is made. In this example, there three are valid kinds of rules:
A rule matching a specific instance, tenant, organization, and department
A rule matching a specific instance, tenant, and organization, but any department
A rule matching a specific instance and tenant, but any organization and any department

There can also be a default rule. This rule specifies the action to take when none of the other rules match.

When the speech recognition configuration service receives the request for a configuration of speech-to-text engines:
1. The rules are evaluated in order from the most specific to the least specific (i.e., the order above).
2. In one example, there may be two possible actions to take when an incoming job matches a rule:
   Use a specified configuration
   Select one of two or more configurations, listed in the action, at random (with equal probability)
3. If an incoming job matches no rules, the default rule is executed.
4. If an incoming job has missing or null values for any of instance, tenant, organization, or department, it is considered to match no rule, and the default rule is executed.
5. In an exemplary embodiment, the rules may be loaded at startup time by the service, from its database, or from a configuration file.
6. The service can have an informational API that lists the set of SR configurations it knows about, and its current rules.
7. For the “random selection” action, the system can pick randomly among the options at the rule level, for example selecting based on certain identities or organizations (as opposed to having it always pick from all known or possible configurations). This allows additional flexibility for experimentation regarding what configurations of engines should be used. In other configurations, the random selection can have a bias. For example, the bias can ensure that no more than ten percent (or other predetermined percentage) of the selections favor engine A versus engine B or engine C. In other cases, the bias can ensure engine A is selected at least twenty percent (or other predetermined percentage) of the time.
8. Once a rule is matched, or using the default rule, then the configuration is selected according to the action specified in the rule. At this point, the speech recognition configuration service can write a record to a score database and return the selected configuration to the caller.

After the initial implementation and training of the predictor system, an additional rule can be implemented, with the system being configured to call a prediction service (a combination of machine learning software and/or models) which can make a recommendation for a speech recognition configuration (i.e., which engines to use) based on aspects of the metadata described above.

For each job processed by the speech recognition configuration service, after the rules are evaluated and the configuration selected, the service can write a record to the score database identifying how the configuration was selected, the record containing, for example:
Instance
TenantID
OrganizationID
DepartmentID
platform module Job ID
Transcription communication module JobId
Rule ID
Configuration selected/returned to caller

Rules can also have an identification which uniquely identifies each rule in the service configuration. The rule that matches for a particular job can be recorded, along with the triggering metadata and the result, for debugging and auditing purposes.

An example rule follows, represented as XML. It is meant as a non-limiting example and illustration only. The specific implementation should follow whatever naming and representation conventions are already used for service configuration, to achieve the same results. In this example, it is assumed that rules are part of static, initialization-time service configuration. To change the rules used by a service, it may be necessary to restart the service.

### Example Rule

```
<rules>
  <sr_configurations>
    <sr_configuration id=’X’ description=’X Transcription service standard model’/>
    <sr_configuration id=’Y’ description=’Y Transcription service standard model’/>
    <sr_configuration id=Z’ description=’Z Transcription service standard model’/>
  </sr_configurations>
  <rule id=’1’>
    <match system=’A’ tenant=’H’ organization=’94’
      department=’216’ description= Chicago office’/>
    <action name=’use’ configuration=’Y Transcription service standard model’/>
  </rule>
  <rule id=’2’>
    <match system=’A’ tenant=’H’ organization=’92’
      description=’Nationwide Claims’/>
    <action name=’use’ configuration=’X Transcription service standard model’/>
  </rule>
  <rule id=’3’>
    <match system=’A’ tenant=’H’/>
    <action name=’randomize’ configurations=’X, Y’/>
  </rule>
  <default_rule name=’use’ configuration=’X Transcription service standard model’/>
</rules>
```

At the top of the rules, the target speech recognition configurations are listed. These descriptors can be used to designate the different configurations known to this instance of platform module. There are three rules in the example. Each has an ID, a <match> part, and an <action> part. The ID for each rule should be unique at load time. The <match> part of each rule should also be different. The <match> parts of the three rules in the example demonstrate each of the allowed kind of rules: one that specifies matching to the department level, one to the organization level, and one to the tenant level. There is also a default rule. The default rule looks like an action because that is the only thing it needs to specify (i.e., the action to take when no rule matches).

Using the example rule, following are example transcription jobs processed by the rule:
Example job 1: system=′A′, tenant=′H′, organizationId=94, departmentId=212
   Although this job matches the organization for rule id=1, it does not match the department (which the rule has as departmentId=216), so it ends up matching rule id=3, the tenant-level rule for H. The speech recognition configuration service will make an equal-weighted random pick between configurations “X Transcription Service” and “Y Transcription Service,” and return the picked configuration.
Example job 2: system=′A′, tenant=′TEST′, organizationId=1, departmentId=1
   All the rules have the tenant ‘H’, so this job, from a different tenant, falls through to the default rule. The service will return the configuration for X Transcription Service.
Example job 3: system=′A′, tenant=′Z′, organizationId=94, departmentId=216
   The service will return the configuration Y, because this job matches all of the criteria for rule id=1.
Example job 4: no metadata passed in
If the caller passes no value in for any of system, tenant, organizationId, or departmentId, the default rule applies, and X Transcription Service standard model is returned.

When rules are created and/or loaded, preferably the following aspects should be validated:
There is at least one configuration specified
The default rule has been specified
There are zero or more specific rules (apart from the default rule—i.e., only the <default rule> is required)
If any rules are present, each rule has a unique ID
Each rule's<match> section is unique, and specifies the right two, three, or four IDs
The name of each action is valid
The ‘configuration’ argument for a ‘use’<action> is valid (i.e., an ID found in <configurations>)
The list in the ‘configurations’ argument for a ‘randomize’<action> is valid

However, the service does not need to validate the values used for any of the <match> arguments. For example, in the example above, when loading the rules, the speech recognition configuration service should not verify if a system meets certain values (e.g., system=?, if the tenant=?, etc.). How this is done can vary between system configurations.

Configurations and rules could be created and persisted in a database. This could be done, for example, in two separate tables. For example, each table can contain the Transcription communication module administrative fields for creation date and creating user, modification date and modifying user, a soft delete flag, soft delete date, and deleting user. A row of the configuration table can contain the name/identifier for a configuration, and the administrative fields. A row of the rule table can contain:
An instance identifier, which preferably is not be NIL or empty
A tenant identifier, which preferably is not be NIL or empty
An organization ID. (A value should be reserved to represent “match any organization”.)
A department ID. (A value should be reserved to represent “match any department”.)
A code for the action (e.g., use or randomize)
A list of one or more configuration identifiers, as arguments for the use or randomize actions

When the rules specify a random selection, the system can assume that there is an equal probability of selecting different configurations of speech recognition engines. Alternatively, the system can have a bias, thereby ensuring that no engine is selected too often (i.e., that the selections are balanced within a predetermined threshold range), and/or ensuring that no engine is selected too infrequently.

The scoring of transcriptions and/or engines can provide data on finished transcription jobs. platform module can then use this data to compute and track speech recognition accuracy, with the accuracy scores being an input to machine learning models which predict the best speech recognition engine(s) and configuration(s) for incoming transcription jobs.

Preferably, platform module obtains access to the speech recognition draft, and the transcription communication module obtains access to the final draft. However, in some configurations only Transcription communication module knows when both drafts are available (i.e., when the job state reaches a “ready to deliver” state). Therefore, it can be necessary for the transcription communication module to call an platform module API, providing at least a notification regarding status. However, communications between Transcription communication module and platform module can occur in any manner necessary for a given configuration.

Once the data is available, the platform module API service can post a message for a scoring request on the task manager queue. The scoring service can pick up and process each of these messages, scoring the speech recognition transcription against the final draft for one pair of documents. This vector of scores can then be stored in the score database, associated with the input instance/tenant/job ID.

The scoring code can produce a vector of output scores and data that can be stored in the score database for the job. Exemplary score/outputs can include:
Word error rate (float)
Diarization error rate (float)
Punctuation edit rate (float)
Length of the SR draft in tokens (int)
Length of the final transcription in tokens (int)
Number of “indistinct/inaudible” notations in the final transcription (int)
Number of speakers in SR draft (int)
Number of speakers in final draft (int)
Core scoring software version identifier (string) (This can be a value retrieved from a core scoring module. Storing it per score in the database allows the system to know exactly which version of the software produced those scores.)

In some configurations, in addition to scoring the transcriptions, the speech recognition engines can be scored. Like the transcriptions, the engines themselves can be scored based on accuracy, however they can also be scored based on cost, power consumption, bandwidth usage, time required for a transcription process to occur, computing cycles/flops, etc. The system can use a combination of the transcription scores and the engine scores to form a model of which engines should be selected to produce the best transcriptions going forward.

This selection based on scores is referred to as a “Predictor Service.” An exemplary sequence using the predictor service can be:

```
Transcription communication module makes job request (with limited metadata) to platform
module --->
  (platform module processing prior to SR Configuration Service call)
  platform module dispatches SR Configuration Service --->
      Rule for incoming job has predicate specifying call the Best Configuration
      Predictor
      SR Configuration service calls Transcription communication module to gather
      additional metadata --->
        <--- Transcription communication module returns additional job metadata
      SR Configuration service calls Configuration Predictor with addl. metadata --->
        Configuration Predictor uses metadata and ML to make prediction
        <--- Configuration Predictor returns selected configuration
        <--- SR Configuration service returns this configuration to platform
        module
```

Platform Module Proceeds with SR Using the Selected Configuration

The inputs to the predictor service model can be, for example, all or a portion of the metadata associated with transcription job—that is, the data provided by Transcription communication module when the job is received. The inputs can also include previous scores for the respective engines, and any topic, context, or other information.

The predictor service can utilize machine learning, where the system self-corrects over time by using feedback and scores from new transcriptions to adjust which engines are assigned and under what circumstances those engines are assigned. This machine learning can, for example, include training a neural network to identify particular variables which make a difference in the overall quality of the final product/transcription, such as the contexts, topics, job creator, time, length of audio, etc. The predictor service model can incorporate the neural network, or (if done without a neural network) can include feedback mechanisms to modify weights associated with different engine assignments.

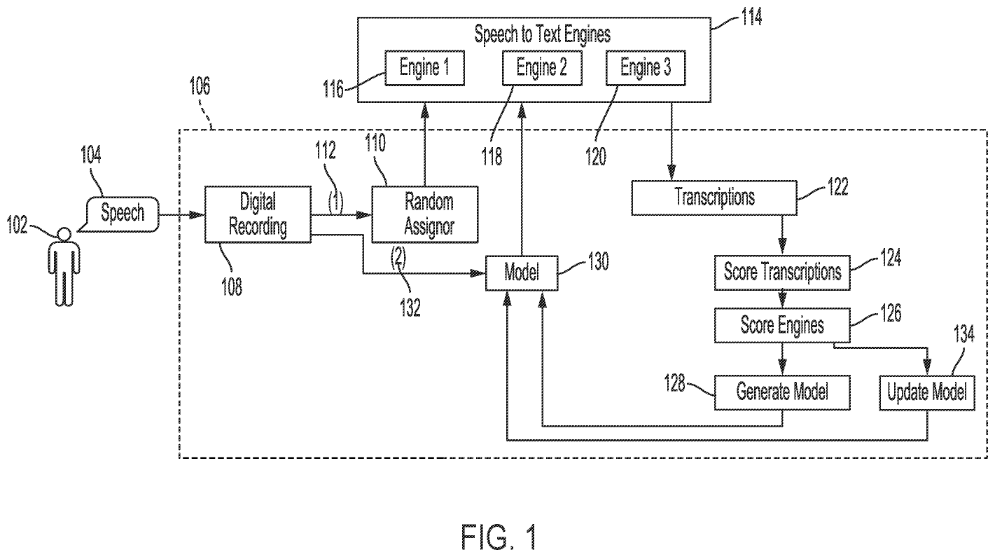

FIG. 1 illustrates a first example system embodiment. In this example, a user 102 produces speech/audio 104, which is received by the system 106. The system 106 converts the speech 104 into a digital recording 108. In a first instance 112, before a model has been generated to assign speech-to-text engines 114 based on context, the user 102, or other factors, the system randomly assigns 110 the digital recording to one or more speech-to-text engines 114. In this illustration there are three engines 116, 118, 120, and in this example all three engines 116, 118, 120 are assigned to transcribe the digital recording 108. The resulting transcriptions 122 are then scored by the system 124. This transcription scoring can, for example, score the transcriptions based on exemplary factors such as word error, diarization error (errors associated with identifying individual speakers within an audio file), punctuation edit metrics within the transcriptions, accuracy, context, etc. The engines 114 themselves can also be scored 126. Exemplary factors for scoring the engines can include, for example, speed, computational requirements (energy use), cost (particularly with cloud computing), bandwidth, etc. In the first instance 112, the resulting scores for the transcriptions and/or the engines are used to generate a model 128 which can be used to assign the speech-to-text engines 114 in the future. In other instances 132, where the model 130 is already generated, the system can assign the engines 114 based on the model recommendations. Upon creating the transcription 122 using the model-assigned engine(s), the system can again score the transcription 124 and/or the engines 126, with the result being an update to the model 134. This update can, for example, constitute an overwrite of the code which assigns the respective engines. In some instances, this overwrite within the system's memory can include replacing weights or values used to make the assignments. In other instances, the overwrite can involve completely reform the model, delete the previous model from memory, and replace it with the updated model.

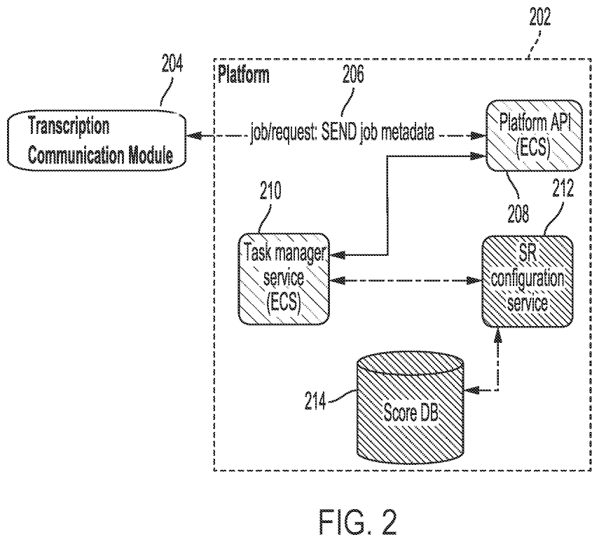

FIG. 2 illustrates an example of creating and integrating a speech recognition configuration service into a system. As illustrated, Transcription communication module 204 can interact with platform module 202, which contains additional modules for this sub-process. Transcription communication module 204 can marshal and pass new job metadata in the body of the platform module job/request call 206 made by an platform module API (Application Programming Interface) caller 208, which is an ECS (Elastic Container Service) (an ECS is a cloud-based application or program which only uses computational power as needed).

This metadata can be specific by a specific research area or topic. Prior to executing speech recognition, the platform module 202 task manager 210 can call a new platform module service (“SR configuration service”) 212, passing in the new job metadata. In some configurations, this speech recognition configuration service 212 can implement a simple lookup table to determine the desired speech-to-text engine (also known as a “configuration”) to use for the job. The lookup table can be tied, for example, to attributes of the metadata associated with a piece of multimedia content. Exemplary engines could be, for example, tuned to specific accents or geography, such as American English, Australian English, Canadian English, Texas English, Scottish English, etc. The use of English is purely exemplary, as other languages, locations, geo-tags, GPS data, or other attributes of the metadata can also be used to determine what engine to use in a given circumstance.

Engines can also be tuned to specific contexts, themes, topics, etc., which can, in some configurations, be determined based on information within the metadata received in the API call 206. The context or topic can also be determined by sampling a portion of an audio file or audio stream and performing a keyword analysis

The selected engine, along with unique identifiers for the job (such as “JobID” with respect to the job identification, and an instance number), can be recorded in a database 214. Throughout, this database is referred to as the “Score DB” 214. This database 214 can be used to record metadata associated with platform module 202 actions, as specified here. This database 214 can be combined with, or part of, an existing platform module 202 database, or a separate database might be used for this purpose in implementation.

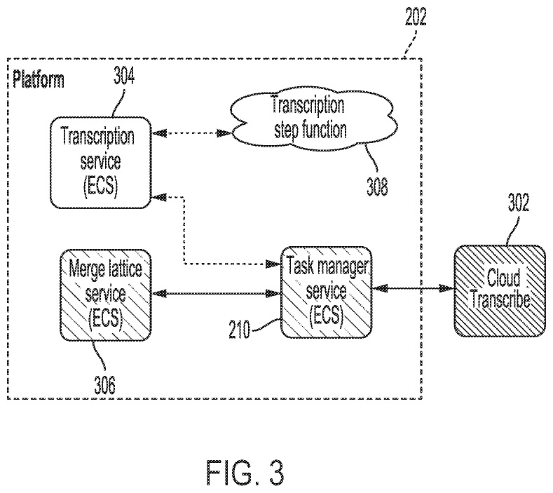

FIG. 3 illustrates an example of integrating cloud-based transcription services, such as Transcription Service 304 (including its step function 308), or cloud-based transcription services 302 into the system. Cloud based transcription services 302 can have capabilities such as custom dictionaries, custom language models, and default models in dozens of languages. The platform module 202 integration preferably can use the custom language model capability from the initial implementation. In some cases, the platform module 202 can parse and relate diarization (the process of partitioning an input audio stream into homogeneous segments according to the speaker identity) and utterance data in an output format (such as a JSON (JavaScript Object Notation), which can be received from the task manager 210 by a merge lattice service 306, which can organize the resulting audio streams and send them to different engines as needed. For example, if a first speaker is detected speaking English with a French accent, and a second speaker is detected speaking English with a New York accent, the system can partition out the audio from the respective speakers and assign the respective audio streams to distinct speech-to-text engines.

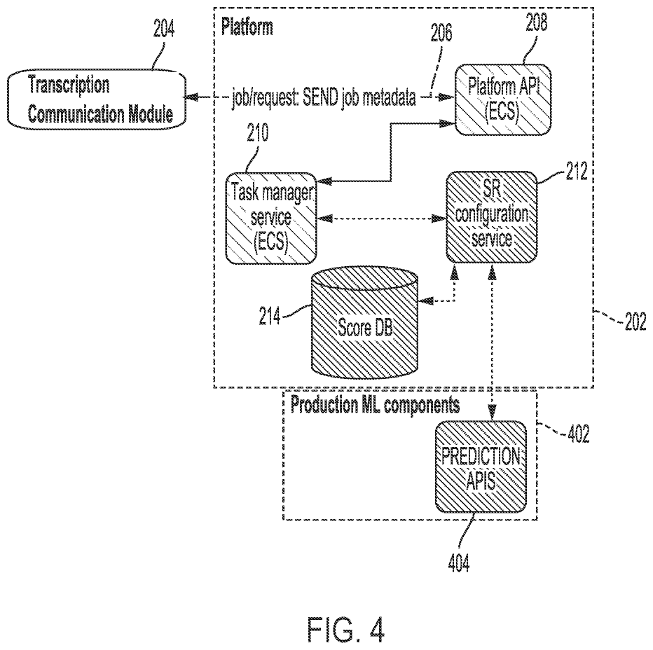

FIG. 4 illustrates an example of integrating a predictor for a speech recognition configuration selection into the system. In this illustration, the speech recognition configuration service 212, previously illustrated in FIG. 2, is further augmented with a the lookup-driven configuration selection, such that a transcription job can specify which speech-to-text engine to use directly, or can cause the service to make a call to a new service (“Prediction APIs”) 404, which will use a machine learning algorithm and model 402 to make the speech recognition engine(s) recommendation.

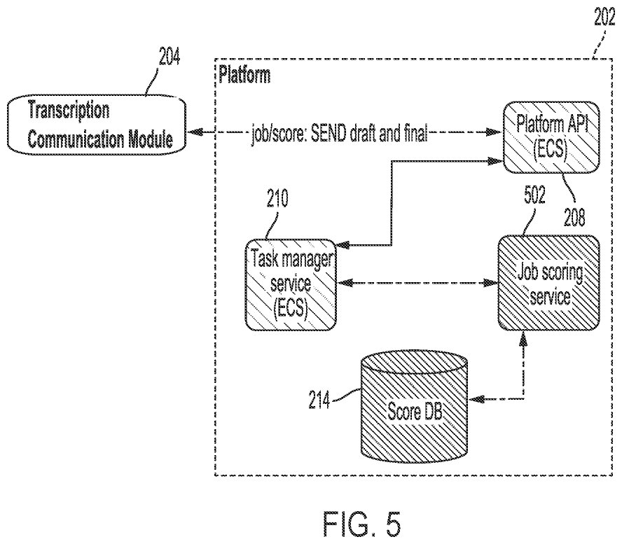

FIG. 5 illustrates an example of adding the ability to score transcription jobs executed by the system. As illustrated, once a transcription reaches a predetermined level of completion, the Transcription communication module 204 can send, via an API call, the draft or final version to the platform module 202 via the platform module API caller 208 for job scoring. The task manager service 210 sends the draft to the job scoring service 502, which can (for example) calculate word error, diarization error, and punctuation edit metrics for the draft. The computed scores can be kept in the score database 214.

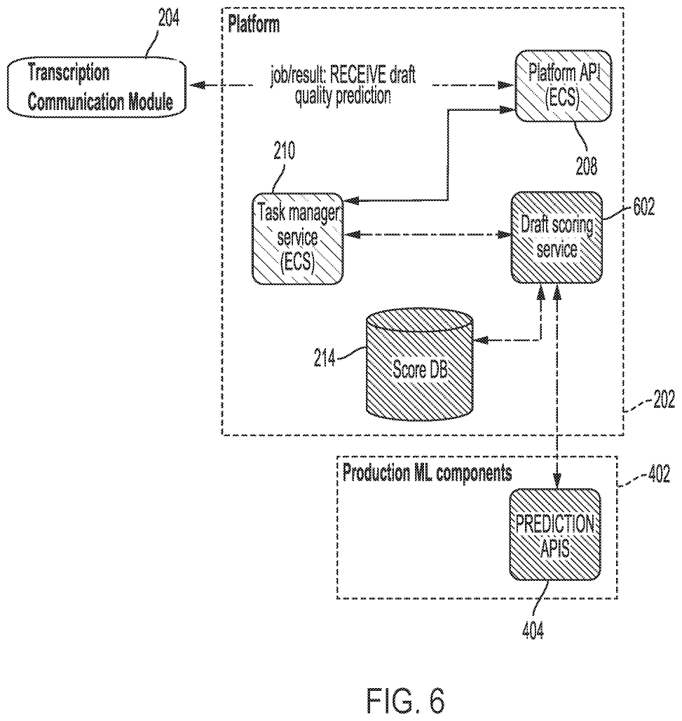

FIG. 6 illustrates an example of integrating a predictor for speech recognition draft quality prediction. In this example configuration, before returning the final draft/results to a client, the platform module task manager 210 will make a call to a “Draft scoring service” 602, including the speech recognition draft. The draft scoring service can marshal and add to the job metadata previously recorded in the score database 214, and then call the prediction APIs 404 within the production machine learning components 402. The prediction APIs 404 can return a prediction regarding the draft quality which can also be stored in the score database 214, and which can also be added to the response body to be returned by the platform module caller 208.

When training the system, the system may ignore the draft quality prediction data. For example, the system may wait until a predetermined threshold of documents have been processed, or until a certain amount of training, has been completed before transmitting or otherwise relying on the predicted quality scores.

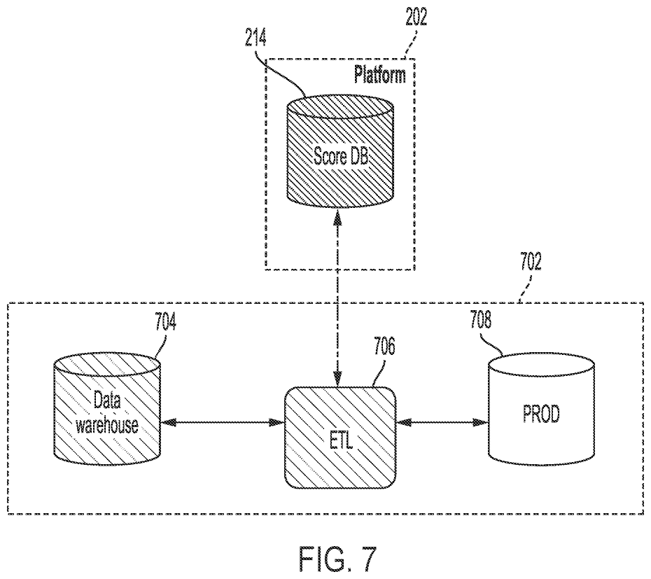

FIG. 7 illustrates an example of ETL (Extract, Transform, Load) changes to support automated model updates. As illustrated, to support automated updates of machine learning models, existing capabilities 702, such as ETL 706 and data warehouse 704, can be expanded so that the score DB 214 data relevant to jobs is easily accessible alongside job metadata from Transcription communication module 204, and productivity data 708.

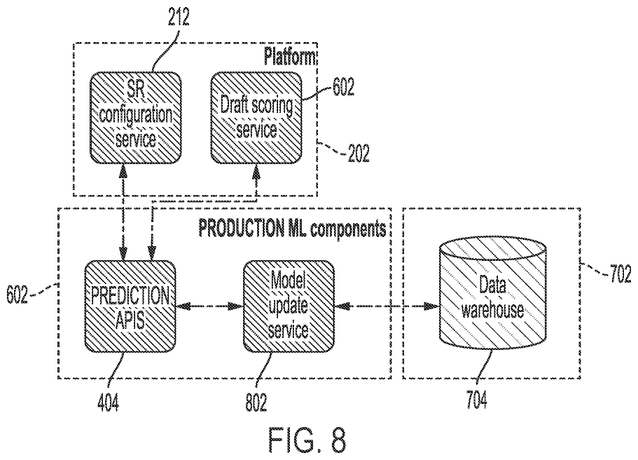

This enables updating prediction models automatically, an example of which is illustrated in FIG. 8. As illustrated in FIG. 8, the machine learning models, stored within the production machine learning components 602 as prediction APIs 404, can be updated by a model update service 802 in communication with the data warehouse 704For example, the system can periodically compile a list of words that were corrected in previous edits by users or by the system. These would be words outside of the ASR engine vocabulary, which can then be used by the system to build or modify a custom dictionary for a particular client/line of business/system.

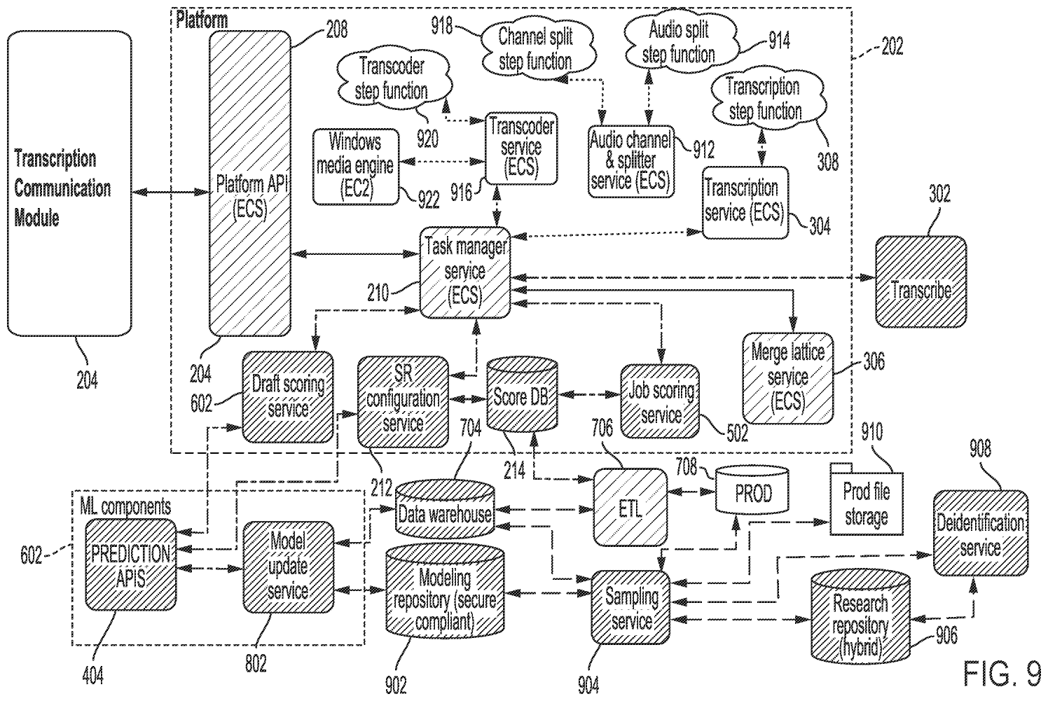

FIG. 9 illustrates a second example system embodiment. In this example many of the modules illustrated and described in FIGS. 2-8 are combined, illustrating the system's overall configuration and interoperability. Among the features not previously described is a modeling repository 902 (which can be secure and compliant). The modeling repository can store models for how audio files should be assigned to one or more speech-to-text engines for transcription. These models can, for example, be updated by the model update service 802. Operating with the modeling repository 902 is a sampling service 904, which can take samples of audio files and be used to predict which models will be most applicable for a given audio file. This in turn can communicate with a research repository 906, which can act as a hybrid between human and computer modeling for what samples should be selected, and when, by the sampling service 904. A deidentication service 908 can be used to remove any metadata which may prejudice or otherwise inappropriately modify how the sampling of the audio file occurs. Also within the illustrated system is a productivity file storage 910, which can store productivity data 708 sampled by the sampling service 904.

The system can also contain an audio channel and splitter service 912, which can split audio signals 914 and split channels 918 using step functions. The system can further contain a transcoder service 916, which can transcode media via a transcoder step function 920 and communicate media content using a media engine 922, which can in an elastic computing cloud format).

It is noted that in some configurations not all these components may be present. For example, in some configurations cloud transcription services 302 may not be present. In other configurations, non-cloud-based transcription services may not be present. In yet other configurations modules such as the modeling repository 902, the sampling service 904, and/or the research repository 906 may not be present.

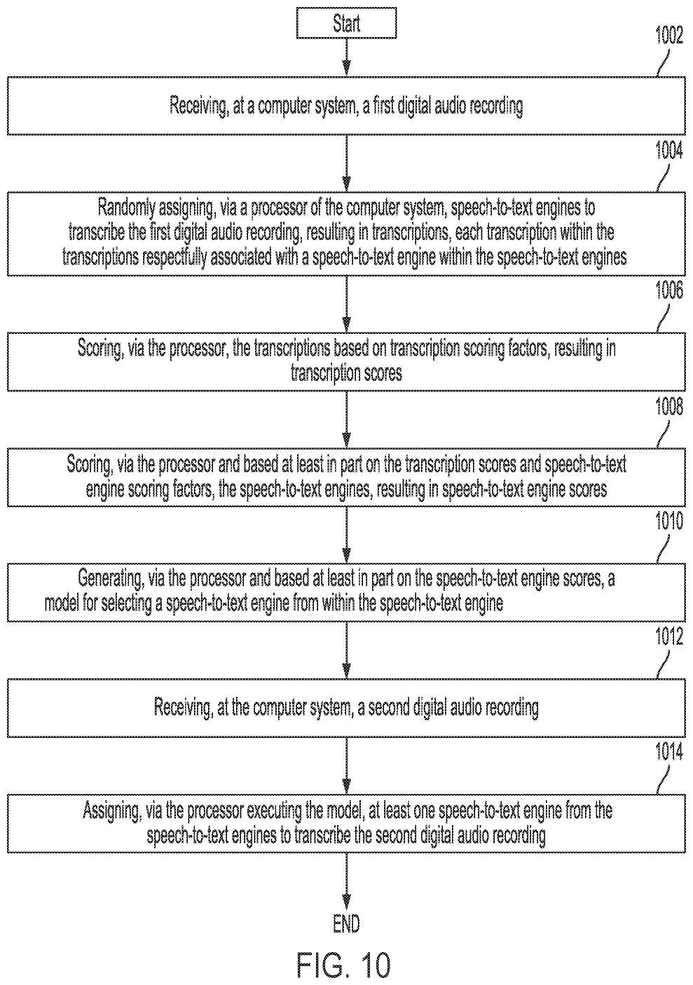

FIG. 10 illustrates an example method embodiment. As illustrated, the method can include receiving, at a computer system, a first digital audio recording (1002) and randomly assigning, via a processor of the computer system, speech-to-text engines to transcribe the first digital audio recording, resulting in transcriptions, each transcription within the transcriptions respectfully associated with a speech-to-text engine within the speech-to-text engines (1004). The method continues with scoring, via the processor, the transcriptions based on transcription scoring factors, resulting in transcription scores (1006) and scoring, via the processor and based at least in part on the transcription scores and speech-to-text engine scoring factors, the speech-to-text engines, resulting in speech-to-text engine scores (1008). Illustrated next is generating, via the processor and based at least in part on the speech-to-text engine scores, a model for selecting a speech-to-text engine from within the speech-to-text (1010) and receiving, at the computer system, a second digital audio recording (1012). The method then concludes with assigning, via the processor executing the model, at least one selected speech-to-text engine from the speech-to-text engines to transcribe the second digital audio recording (1014).

In some configurations, the scoring of the speech-to-text engines is further based on metadata of the original audio.

In some configurations, the speech-to-text engines generate transcription metadata, and the scoring of the speech-to-text engines is further based on the transcription metadata.

In some configurations the speech-to-text engines are cloud based.

In some configurations the transcriptions are generated by the speech-to-text engines operating in parallel.

In some configurations the model is a neural network.

In some configurations, the illustrated method can be further augmented to include: receiving, from the at least one selected speech-to-text engines, second transcriptions, the second transcriptions being transcriptions of the second digital audio recording; scoring, via the processor, the second transcriptions based on the transcription scoring factors, resulting in second transcription scores; scoring, via the processor and based at least in part on the second transcription scores and the speech-to-text engine scoring factors, the at least one selected speech-to-text engines, resulting in second speech-to-text engine scores; and modifying the model based on the second speech-to-text engine scores. In such configurations, the modifying of the model can be further accomplished by: storing the model in a repository of models; periodically retrieving prediction data generated by the model prior to the assigning of the at least one selected speech-to-text engines, the prediction data stored in a database until retrieved; periodically retrieving workflow job data generated by the model, the workflow job data stored in the database until retrieved; retrieving the model from the repository of models; modifying, via the processor, the model based on at least the second speech-to-text engine scores, the prediction data, and the workflow job data, resulting in an updated model; and replacing, within the repository of models, the model with the updated model.

In some configurations, the scoring of the transcriptions via the processor is done in combination with human based review of the transcriptions. In other configurations, the scoring is done using an automated scoring system which calculates at least one of word error, diarization error, and/or punctuation edit metrics within the transcriptions.

In some configurations, the transcription scoring factors include at least one of accuracy and context; and the speech-to-text engine scoring factors include at least one of speed (of the speech-to-text engines), computational requirements (of the speech-to-text engines), and/or bandwidth of communications (with the speech-to-text engines).

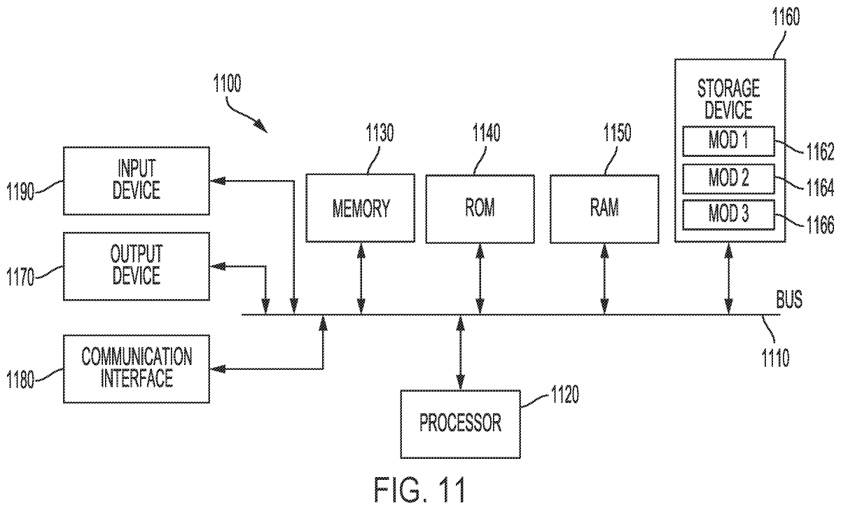

With reference to FIG. 11, an exemplary system includes a general-purpose computing device 1100, including a processing unit (CPU or processor) 1120 and a system bus 1110 that couples various system components including the system memory 1130 such as read-only memory (ROM) 1140 and random access memory (RAM) 1150 to the processor 1120. The system 1100 can include a cache of high-speed memory connected directly with, in close proximity to, or integrated as part of the processor 1120. The system 1100 copies data from the memory 1130 and/or the storage device 1160 to the cache for quick access by the processor 1120. In this way, the cache provides a performance boost that avoids processor 1120 delays while waiting for data. These and other modules can control or be configured to control the processor 1120 to perform various actions. Other system memory 1130 may be available for use as well. The memory 1130 can include multiple different types of memory with different performance characteristics. It can be appreciated that the disclosure may operate on a computing device 1100 with more than one processor 1120 or on a group or cluster of computing devices networked together to provide greater processing capability. The processor 1120 can include any general purpose processor and a hardware module or software module, such as module 1 1162, module 2 1164, and module 3 1166 stored in storage device 1160, configured to control the processor 1120 as well as a special-purpose processor where software instructions are incorporated into the actual processor design. The processor 1120 may essentially be a completely self-contained computing system, containing multiple cores or processors, a bus, memory controller, cache, etc. A multi-core processor may be symmetric or asymmetric.

The system bus 1110 may be any of several types of bus structures including a memory bus or memory controller, a peripheral bus, and a local bus using any of a variety of bus architectures. A basic input/output (BIOS) stored in ROM 1140 or the like, may provide the basic routine that helps to transfer information between elements within the computing device 1100, such as during start-up. The computing device 1100 further includes storage devices 1160 such as a hard disk drive, a magnetic disk drive, an optical disk drive, tape drive or the like. The storage device 1160 can include software modules 1162, 1164, 1166 for controlling the processor 1120. Other hardware or software modules are contemplated. The storage device 1160 is connected to the system bus 1110 by a drive interface. The drives and the associated computer-readable storage media provide nonvolatile storage of computer-readable instructions, data structures, program modules and other data for the computing device 1100. In one aspect, a hardware module that performs a particular function includes the software component stored in a tangible computer-readable storage medium in connection with the necessary hardware components, such as the processor 1120, bus 1110, display 1170, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 1100 is a small, handheld computing device, a desktop computer, or a computer server.

Although the exemplary embodiment described herein employs the hard disk 1160, other types of computer-readable media which can store data that are accessible by a computer, such as magnetic cassettes, flash memory cards, digital versatile disks, cartridges, random access memories (RAMs) 1150, and read-only memory (ROM) 1140, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 1100, an input device 1190 represents any number of input mechanisms, such as a microphone for speech, a touch-sensitive screen for gesture or graphical input, keyboard, mouse, motion input, speech and so forth. An output device 1170 can also be one or more of a number of output mechanisms known to those of skill in the art. In some instances, multimodal systems enable a user to provide multiple types of input to communicate with the computing device 1100. The communications interface 1180 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
receiving, at a computer system, a first digital audio recording;
randomly assigning, via a processor of the computer system, speech-to-text engines to transcribe the first digital audio recording, resulting in transcriptions, each transcription within the transcriptions respectfully associated with a speech-to-text engine within the speech-to-text engines;
scoring, via the processor, the transcriptions based on transcription scoring factors, resulting in transcription scores;
scoring, via the processor and based at least in part on the transcription scores and speech-to-text engine scoring factors, the speech-to-text engines, resulting in speech-to-text engine scores;
generating, via the processor and based at least in part on the speech-to-text engine scores, a model for selecting a speech-to-text engine from within the speech-to-text engines;
receiving, at the computer system, a second digital audio recording; and
assigning, via the processor executing the model, at least one selected speech-to-text engine from the speech-to-text engines to transcribe the second digital audio recording.

2. The method of claim 1, wherein the scoring of the speech-to-text engines is further based on metadata of the original audio.

3. The method of claim 1, wherein:
the speech-to-text engines generate transcription metadata; and
the scoring of the speech-to-text engines is further based on the transcription metadata.

4. The method of claim 1, wherein the speech-to-text engines are cloud based.

5. The method of claim 1, wherein the transcriptions are generated by the speech-to-text engines operating in parallel.

6. The method of claim 1, wherein the model is a neural network.

7. The method of claim 1, further comprising:
receiving, from the at least one selected speech-to-text engines, second transcriptions, the second transcriptions being transcriptions of the second digital audio recording;
scoring, via the processor, the second transcriptions based on the transcription scoring factors, resulting in second transcription scores;
scoring, via the processor and based at least in part on the second transcription scores and the speech-to-text engine scoring factors, the at least one selected speech-to-text engines, resulting in second speech-to-text engine scores; and
modifying the model based on the second speech-to-text engine scores.

8. The method of claim 7, wherein the modifying of the model is further accomplished by:
storing the model in a repository of models;
periodically retrieving prediction data generated by the model prior to the assigning of the at least one selected speech-to-text engines, the prediction data stored in a database until retrieved;
periodically retrieving workflow job data generated by the model, the workflow job data stored in the database until retrieved;
retrieving the model from the repository of models;
modifying, via the processor, the model based on at least the second speech-to-text engine scores, the prediction data, and the workflow job data, resulting in an updated model; and
replacing, within the repository of models, the model with the updated model.

9. The method of claim 1, wherein the scoring of the transcriptions via the processor is done in combination with human based review of the transcriptions.

10. The method of claim 1, wherein:
the transcription scoring factors comprise at least one of accuracy and context; and
the speech-to-text engine scoring factors comprise at least one of speed, computational requirements, bandwidth.

11. A system comprising:
a modeling repository;
a score database;
at least one processor; and
a non-transitory computer-readable storage medium having instructions stored which, when executed by the at least one processor, cause the at least one processor to perform operations comprising:
executing a task manager service; and
executing a scoring service;
wherein the system generates a speech-to-text engine assignment model by:
receiving a first digital audio recording;
randomly assigning, via the task manager service, speech-to-text engines to transcribe the first digital audio recording, resulting in transcriptions, each transcription within the transcriptions respectfully associated with a speech-to-text engine within the speech-to-text engines;
scoring the transcriptions based on transcription scoring factors, resulting in transcription scores;
storing the transcription scores in the score database;
scoring, based at least in part on the transcription scores stored in the score database and speech-to-text engine scoring factors, the speech-to-text engines, resulting in speech-to-text engine scores;
storing the transcription scores in the score database;
generating, based at least in part on the speech-to-text engine scores stored in the score database, a model for selecting a speech-to-text engine from within the speech-to-text engines for a future transcription; and
storing the model in the modeling repository; and
wherein the system uses the model to make additional speech-to-text engine assignments by:
receiving a second digital audio recording;
retrieving the model from the modeling repository; and
assigning, by executing the model, a particular speech-to-text engine from the speech-to-text engines to transcribe the second digital audio recording.

12. The system of claim 11, wherein the scoring of the speech-to-text engines is further based on metadata of the original audio.

13. The system of claim 11, wherein:
the speech-to-text engines generate transcription metadata; and
the scoring of the speech-to-text engines is further based on the transcription metadata.

14. The system of claim 11, wherein the speech-to-text engines are cloud based.

15. The system of claim 11, wherein the transcriptions are generated by the speech-to-text engines operating in parallel.

16. The system of claim 11, wherein the model is a neural network.

17. The system of claim 11, wherein the scoring of the transcriptions via the processor is done in combination with human based review of the transcriptions.

18. The system of claim 11, wherein:
the transcription scoring factors comprise at least one of accuracy and context; and
the speech-to-text engine scoring factors comprise at least one of speed, computational requirements, bandwidth.

19. A non-transitory computer-readable storage medium having instructions stored which, when executed by a processor, cause the processor to perform operations comprising:
receiving a first digital audio recording;
randomly assigning speech-to-text engines to transcribe the first digital audio recording, resulting in transcriptions, each transcription within the transcriptions respectfully associated with a speech-to-text engine within the speech-to-text engines;
scoring the transcriptions based on transcription scoring factors, resulting in transcription scores;
scoring, based at least in part on the transcription scores and speech-to-text engine scoring factors, the speech-to-text engines, resulting in speech-to-text engine scores;
generating, based at least in part on the speech-to-text engine scores, a model for selecting a speech-to-text engine from within the speech-to-text engines for a future transcription;
receiving a second digital audio recording; and
assigning, by executing the model, a particular speech-to-text engine from the speech-to-text engines to transcribe the second digital audio recording.

20. The non-transitory computer-readable storage medium of claim 19, wherein the scoring of the speech-to-text engines is further based on metadata of the original audio.
